(19) United States
(12) Patent Application Publication
(10) Pub. No.: US 2004/0185167 A1
(43) Pub. Date: Sep. 23, 2004

(54) Method and device for dosing fluid media

(76) Inventors: Heiko Zimmermann, St Ingbert (DE); Rolf Hagerdorn, Berlin (DE); Gunter Fuhr, Berlin (DE)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/481,076

(22) PCT Filed: Jun. 12, 2002
(86) PCT No.: PCT/EP02/06470

(30) Foreign Application Priority Data
Jun. 18, 2001 (DE) 101 29 243.0

(51) Int. Cl. B05D 3/00; B01L 3/02

(52) U.S. Cl. 427/2.1; 427/282; 118/301

(57) ABSTRACT

A dosing method, particularly for microdosing fluid media, is described, in which at least one drop (11) is generated using a drop generator (10) and moved on a free flight path (12) which is directed toward a target (30), the drop (11) being incident on a masking device (20) having at least one structure element (21-28), which projects into the flight path (12) and on which at least one partial drop (13, 15-18) is detached from the drop (11), and the at least one partial drop is transferred onto the target. A dosing device for performing the method is also described.

The present invention relates to methods for dosing fluid media, particularly dosing methods for transferring fluid, drop-shaped samples in accordance with predetermined material and/or geometric conditions onto a target, methods for material modification of samples in drops, and methods for modifying substrate surfaces by supplying fluid media in drops in accordance with a predetermined geometric pattern. The present invention also relates to devices for implementing the methods cited.

The targeted generation, distribution, and arrangement of small liquid volumes has great practical significance, particularly in biotechnology and medicine. For example, for constructing test assays for screening methods in pharmaceutical research, there is an interest in the defined depositing of fluid samples onto substrates. Accordingly, in the construction of sample banks, particularly cryobanks, a technique is also necessary, using which cell suspensions, for example, may be dosed in a defined way and positioned on a substrate or in a matrix of cryo containers. The samples typically have a volume in the μ1 to p1 range. Therefore, in the methods of interest, microdosing is also referred to.

In generally known, conventional methods for microdosing, capillaries, needle tips, or micropumps, for example, are used as devices for producing samples in drops. These devices have a double function as a drop generator and as a dosing unit. The sample drops are transferred with a defined size and composition from the drop generator along a specific free movement path to a target, e.g., a substrate. After leaving the drop generator, the samples typically remain uninfluenced until reaching the target. In order to cover specific target positions, the drop generator and the target are mechanically movable in relation to one another.

The conventional microdosing methods have a plurality of disadvantages, through which their applicability is restricted. Only limited dosing speeds are achievable using individual drop generators. If several thousand samples are to be placed on a substrate, so much time is necessary for the serial distribution using one single drop generator that a change of the first sample may possibly have occurred before the last sample is placed. Drop generators for simultaneous generation of multiple sample drops are known (e.g., multi-capillary systems), using which the speed may be elevated. However, these devices have a complicated construction and a relatively high susceptibility to breakdown. Adaptation to different dosing conditions is only possible through modification of the drop generator.

A further disadvantage of typical drop generators is their restriction of the samples generated to predetermined minimum volumes, which, depending on the generator function, the samples may not fall below. However, in the development of novel screening systems, a reduction of the sample volumes is always required, in order to position the samples more densely on substrates or to save reagents, for example.

The object of the present invention is to provide an improved dosing method, using which the disadvantages of the conventional techniques may be overcome. The dosing method according to the present invention is particularly to allow precise and reproducible dosing of fluid media. The object of the present invention is also to provide an improved dosing device for implementing the method.

These objects are achieved by a dosing method and a dosing device having the features according to claims 1 and 10. Advantageous embodiments and applications of the present invention result from the dependent claims.

The basic idea of the present invention is to modify at least one drop of a fluid media, which has been generated using a drop generator and is moved along a free flight path, through interaction with a masking device positioned in the flight path, which has at least one structure element, in such a way that at least one partial drop is detached from the originally generated drop. For the dosing according to the present invention, at least one partial drop or a portion is detached from an originally generated drop and, depending on the properties of the masking device which is positioned between the drop generator and the target, is modified in regard to the impulse properties and possibly the material composition. Dosing is generally understood here to mean the provision of liquid samples in drops, which are distinguished by a specific mass (or a specific volume), a specific speed, a specific movement direction, a specific position, and/or a specific material composition.

According to a preferred embodiment of the present invention, at least one drop is divided in each case into multiple partial drops. For this purpose, the structure element of the masking device has the form of a perforated or lattice mask. A drop originally generated using the drop generator is converted at the masking device into multiple partial drops which, depending on the design of the structure element, have a specific distribution and movement direction. The structure element of the masking device is preferably positioned at a distance to the target and is movable in relation to the target. This advantageously opens up an additional degree of freedom in the setting of the dosing parameters and possibly the replacement of the structure element in the course of a dosing method.

The at least one structure element of the masking device used according to the present invention forms a mechanical mask of the flight path of the at least one generated drop. In general, the structure element has a specific geometrical arrangement of mask openings, which are each delimited by edges. The mask openings are arranged as a flat or curved mask. The opening shapes and possibly the folding or curvature of the mask allow the setting of any arbitrary sample volumes and patterns of the partial droplets which pass the mask openings. According to a particular embodiment of the present invention, the masking device itself may be loaded with at least one substance, with which the partial droplets are loaded during generation at the at least one structure element. Starting from one generated drop, for example, which moves from the drop generator through the masking device, multiple partial drops are loaded with the at least one additional substance and then deposited on the target. The time problem cited above in the substrate charging is solved both in regard to parallel placement of multiple partial drops and in regard to loading with an additional substance.

According to the present invention, multiple masking devices may be provided along the movement path, the partial drops generated at a masking device being subjected to further dosing, particularly partial drop formation, deflection, and/or material modification at the following masking device in the movement direction.

The subject of the present invention is also a dosing device for implementing the novel dosing method, which is particularly characterized by a drop generator for generating drops and a masking device having at least one structure element for modifying and microdosing the drops.

The present invention has the following advantages. The microdosing method allows the simultaneous distribution of a substance (e.g., suspension or solution of a sample to be assayed) onto multiple positions on a target. The samples are placed at precise points. The masking device and particularly the structure element may be used once or multiple times as a function of the application. The structure element is simple to produce and allows replacement without problems. Materials, such as nozzles of a drop generator, do not have to be cleaned separately. The dosing has a high speed, since the partial drops are generated simultaneously. It is advantageous in the biomedical field in particular that no substrate pretreatment is necessary for producing structured charged substrates. The method according to the present invention may be implemented without anything further in process cycles which fulfill GMP (good manufacturing practice) and GLP (good laboratory practice) conditions. A further advantage of the present invention is the possibility of producing masks which are geometrically and materially non-uniform, so that the target is loaded inhomogeneously with size or material gradients.

The present invention has manifold applications. Samples may be applied to substrates and/or substrate surfaces may be modified (e.g., structured surface gel cross-linking using salt solutions distributed according to the present invention). Besides usage in biotechnology, genetic technology, and biomedicine, there are also applications in printing technology, for example. With masking devices used according to the present invention, the printing parameters, particularly the printing resolution, of an inkjet printer may be varied.

Further details and advantages of the present invention result from the description of the attached drawing.

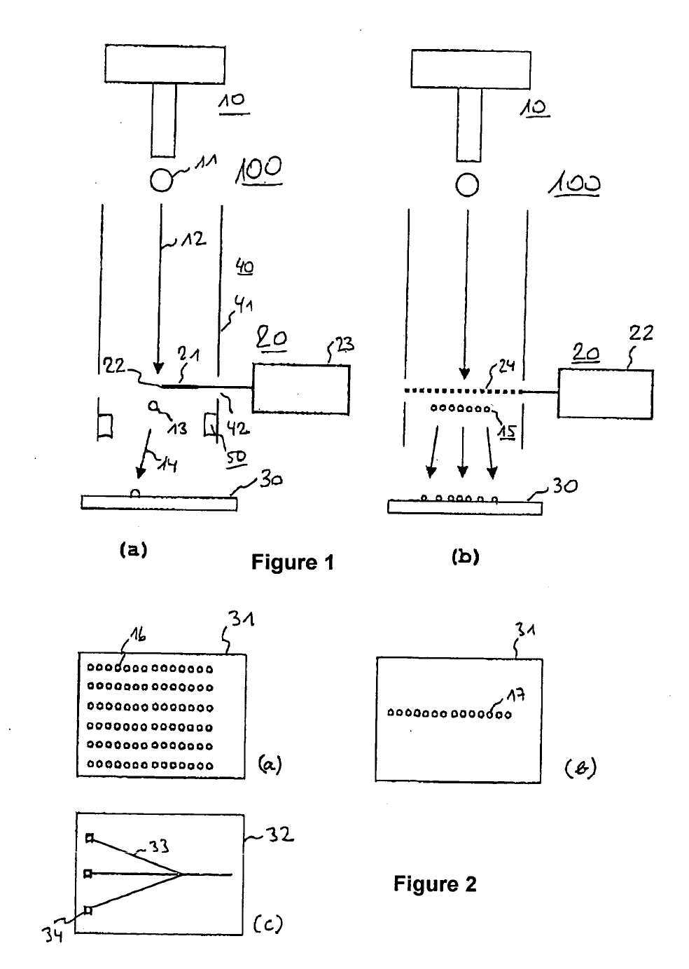

FIGS. 1a, b show schematic illustrations of dosing devices according to the present invention,

FIGS. 2a through c show exemplary illustrations of the placement of fluid media on targets using different patterns,

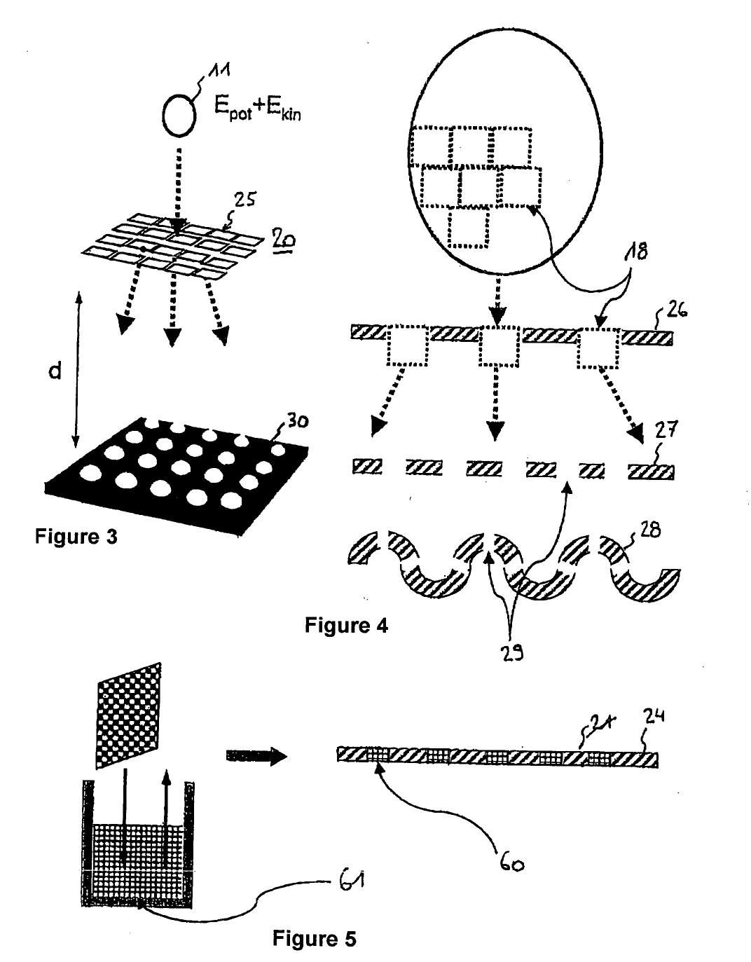

FIG. 3 shows a further illustration of the generation of partial drops according to the present invention on a perforated mask,

FIG. 4 shows an illustration of different functions of structure elements used according to the present invention,

FIG. 5 shows an illustration of the loading of a masking device with additional substances,

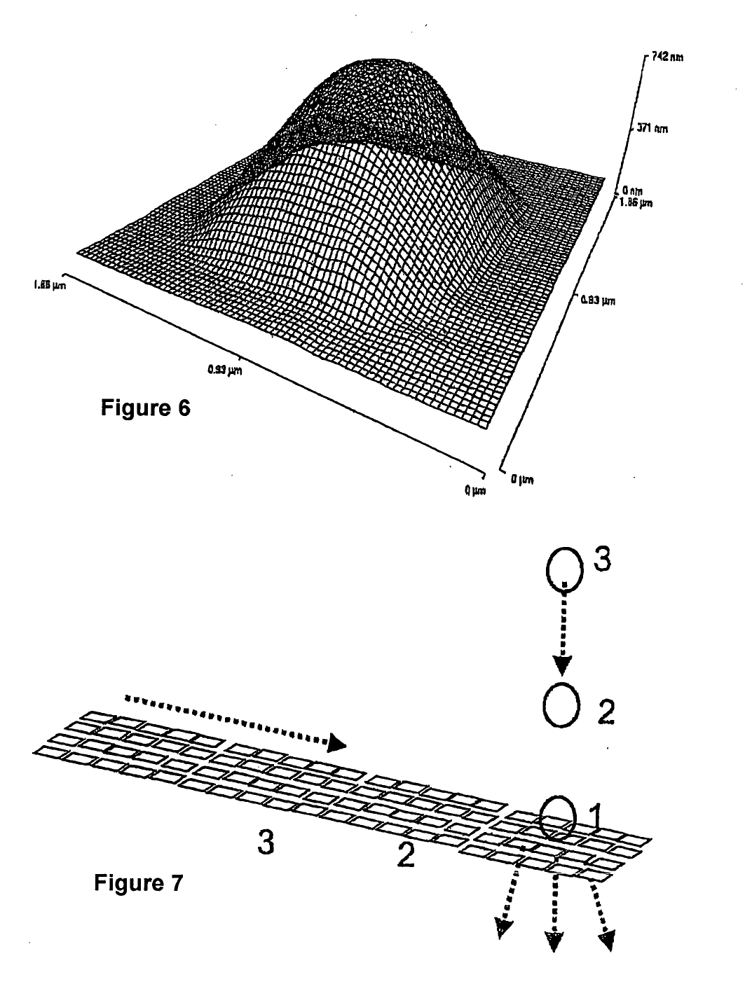

FIG. 6 shows an exemplary illustration of a masking device used according to the present invention having a curved structure element, and

FIG. 7 shows an illustration of a mode of operation of the dosing device according to the present invention having a movable masking device.

FIG. 1 shows a schematic side view of the construction of a dosing device 100 according to the present invention having a drop generator 10, a masking device 20, and a target 30. The drop generator 10 generally includes a device from which at least one drop 11 exits along a specific flight path 12 toward the target 30. The drop generator 10 may, for example, be formed by a dosing unit known per se, in which drops are delivered by a capillary or using a pipette or a micropump or the like. The drop generator may also be set up for simultaneous delivery of multiple drops, using a multi-capillary system, for example, the dosing according to the present invention then being performed using one or more of the drops delivered. As a function of the application, the drop generator may be adapted to deliver individual drops or to deliver individual drop sequences (pulsed drop generation, e.g., bubble jet method). The target 30 is generally a body having an exposed solid surface onto which at least one partial drop is to be transferred. The target 30 is preferably a planar substrate (e.g., glass, plastic, film, semiconductor material, or the like), which has a smooth or structured surface. The surface of the target 30 may particularly be equipped with devices for manipulating, analyzing, or detecting fluid samples, as they are known from fluidic microsystem technology, for example.

The masking device 20 includes at least one structure element 21, 24, at least one outer edge 22 of which projects into the flight path 12 of the drop 11, and a positioning device 23, using which the at least one structure element 21, 24 is adjustable or movable in all three spatial directions in relation to the flight path 12 and/or in relation to the target 30. The partial figures (a) and (b) of FIG. 1 illustrate two basic forms of structure elements used according to the present invention. The structure element 21 shown in partial figure (a) is set up to generate one partial drop 13 from the originally generated drop 11. The partial drop 13 differs from the drop 11 in regard to its size and movement direction. Through the collision with the outer edge 22 of the structure element 21 projecting into the flight path 12, the drop 11 is divided into the partial drop 13 and a remainder (not shown), the partial drop 13 being deflected to a new direction (see arrow 14). Alternatively, the structure element 24 shown in partial image (b) may have multiple openings, each having edges which project into the movement path 12 of the drop 11. In this case, multiple partial drops 15 torn off at the edges and passing through the openings are generated, which may be transferred to the target 30, possibly again with a deflection in relation to the original flight path 12.

Furthermore, a dosing device according to the present invention may be equipped with a shield device 40, which shields the spatial region in which the drop 11 moves toward the masking device 20 and the partial drops 13, 15 are generated, from the environment. For example, a tubular housing 41 is provided which extends along the flight path 12 and has a lateral opening 42, through which the at least one structure element 21, 24 projects into the flight path. Furthermore, the dosing device 100 may have additional detector and/or modulator devices 50, particularly positioned downstream in the drop movement direction of the masking device, using which the generation of the partial drops 13, 15 is detected or a further modulation of the movement path of the partial drops is performed using electric fields, for example (see below).

In the further description, reference is made to the preferred use of a structure element 24 as shown in FIG. 1b, which is formed by a flat mask having multiple two-dimensional or arrayed mask openings. The structure element 24 is also referred to as a perforated mask or lattice mask.

The perforated or lattice mask includes a thin planar or curved plate or disk in which the mask openings are formed as through holes. The geometric shape of the mask openings (e.g., round, angular), the number and arrangement of the mask openings (regular, two-dimensional, rowed, or irregular), and the intervals of the mask openings are selected as a function of the application. In general, the inner dimension of the mask openings is significantly smaller than the diameter of the originally generated drop 11. The quotient of the drop diameter and the inner dimension of the mask openings is selected, for example, in the range from approximately 10 to 500, e.g. 100. The smaller the quotient is, the more partial drops 15 are generated and transferred in a defined way to the target 30 during the dosing method according to the present invention. The intervals between the mask openings may be formed by strip-shaped ribs (see FIG. 3), whose width may be reduced down to a wire shape (see FIG. 6), so that the intervals of the mask openings are possibly smaller than the inner dimension of the mask openings. The thickness of the mask or at least the edge of the structure element is preferably selected in the range from a few mm to 100 μm. The lower limit may also be smaller as a function of the application if the mask is sufficiently stable for the particular drops applied.

For the construction shown in FIG. 1b, the drop generator 10 is formed by a micropipette, for example, which delivers drops having a volume of approximately 13 μl. The drops 11 fall under the effect of gravity along a straight flight path 12 over a distance of approximately 50 cm to the latticed structure element 24. The mask openings of the structure element 24 are squares having a side length of 100 μm. At the structure element 24, the drops 11 are divided into multiple partial drops 15 (e.g., a few tens to a few 10³ partial drops or more), which are transferred in accordance with the arrangement of the mask openings in the structure element 24 to the target 30 and there form a drop pattern which is identical or geometrically similar (possibly expanded or focused) to the pattern of the mask openings. The perpendicular distance between the structure element 24 and the target 30 is, for example, in the mm to cm range.

A schematic top view of various deposit forms of the partial drops is illustrated in FIG. 2. As shown in FIG. 2a, a matrix-like deposition of the samples 16 occurs in straight rows and columns on the planar substrate 31, as is of interest for test assays, for example. To distribute a cell suspension drop onto a substrate using a controlled pattern as shown in FIG. 2a, a starting drop having approximately 5*10² cells passes through the structure element of the masking device, for example.

Division into multiple samples (partial drops) having an average of two cells per sample occurs. Alternatively, a linear array of samples 17 as shown in FIG. 2b may also be provided. This embodiment of the present invention is applied especially advantageously in investigations of cell cultivations or cell traces on substrates. Using the dosing device according to the present invention, partial drops which each contain an average of one biological cell suspended in a nutritional solution are applied in a row or in another geometric arrangement onto the substrate 31. The cells are given a defined starting position using the dosing according to the present invention. For cultivation or trace production purposes, a structure may be provided on the substrate 31 in specific substrate regions to encourage the particular process to be observed, as is known per se from cell trace assays. As shown in FIG. 2c, an exposed fluidic microsystem 32 may also be used as a target. Fluid channels 33 are formed in the chip surface of the microsystem 32 in a way known per se. Using a suitably shaped and positioned masking device, samples are placed in specific start reservoirs 34 of the microsystem 32 and conveyed from there through the channels 33.

In the following, further particulars of the dosing according to the present invention are explained with reference to the schematic illustration in FIG. 3. FIG. 3 shows a dosing device according to the present invention having a masking device 20 and a target 30. The drop 11, which is shown greatly reduced in size for reasons of clarity, falls onto the structure element 25 of the masking device 20. The energy of the drop 11 is composed of its potential energy and its kinetic energy. The larger the distance of the masking device from a drop generator passed through in free fall, for example, or the smaller the distance d of the masking device from the target, the more potential energy is converted into kinetic energy. Upon impact of the drop 11 on the masking device 20, the impulse of the partial drop exiting from the masking device 20 is changed in relation to the impulse of the original drop 11. Both the volumes of the partial drops, i.e., their masses, and the speeds in relation to their absolute value and possibly also their direction, change. The inventors have found that under given geometrical conditions of the relative arrangements of the masking device 20 and the target 30 and the mask openings in the structure element 25 of the masking device 20 for given drop properties, surprisingly, a defined and reproducible change of the impulse and division of the drop into partial drops occurs. Using the masking device 20, the partial drops may be shaped and guided in a defined way. A further variation possibility results from the mobility of the masking device 20 in relation to the target 30. Upon a change of the distance d, the arrangement of the partial drops on the target 30 may be changed in a defined way. Finally, it is also possible to cause the impulse change through variation of the mask. The structure element of the masking device may, for example, be macroscopically curved (see FIG. 4, bottom; FIG. 6). Furthermore, variability of the mask openings may be provided, by making the ribs between the mask openings have their width changeable using lamellae, for example.

According to an alternative embodiment of the present invention, it is possible for a masking device to be provided with multiple structure elements positioned one behind another in the movement direction of the drop or, correspondingly, for multiple masking devices to be provided positioned one behind another, each having a structure element (mask cascade). An example of a mask cascade having the structure elements 26, 27, and 28 is illustrated in FIG. 4. The drop 11 is incident on the first mask. The schematically illustrated division of the drop 11 into the partial drops 18 occurs, which are incident on the following mask, which has a changed geometry (particularly a changed arrangement and/or size of the mask openings 29).

The lowermost mask 28 illustrated in FIG. 4 shows a further possibility of influencing the direction of the partial drops generated. Through a mask curve in the movement direction, an expansion of the partial drop distribution projected from the masking device onto the target may be achieved. Vice versa, through a curve against the movement direction, focusing of the partial drop distribution is possible. Finally, a waved or paraboloid form may also be provided, as shown, using which a defined structuring of the partial drop distribution on the target is produced.

It is a special advantage of the present invention that, particularly through the focusing of the partial drop distribution, fluid media having extremely small volumes (e.g., less than 1 pl) may be deposited in a defined way in a very narrow space (e.g., a few μm). Sample densities of this type are not achievable using typical dosing devices.

In a practical design of a mask cascade, two masks positioned one behind another may be provided, for example. The first lattice mask is used for dividing an original drop generated by the drop generator into a uniform field of partial drops (e.g., matrix arrangement). Using the second lattice, a gradient is generated in the partial drop field. For this purpose, the mask openings of the second lattice mask are not shaped uniformly, but with different inner dimensions of the mask openings. For example, a matrix arrangement of the mask openings in straight rows and columns may be provided, the mask openings each getting larger or smaller in steps in the column and row directions.

The material composition of the partial drops may also be modified through the interaction with the masking device, as is illustrated in FIG. 5. The structure element 24 of the masking device is, for example, a flat lattice mask as in FIG. 1b. An additional substance 60 is positioned in some or all of the mask openings. The additional substance 60 includes, for example, liquid reagents which are to be caused to react with the partial drops. The loading of the structure element 21 with the additional substance 60 is preferably performed by simply dipping the lattice mask into a supply vessel 61. Under the effect of the adhesion forces, the additional substance 60 is bound in the mask openings, which have typical inner dimensions in the range of a few millimeters to a few μm for this purpose. Through the technique illustrated in FIG. 5, it becomes possible to allow reactions to occur on the surface of the partial drops which are to occur only immediately before incidence of the partial drops on the target.

FIG. 6 illustrates an example of the design of a macroscopically shaped lattice mask having a curve which, depending on the alignment in relation to the movement direction of the drops, is used for focusing or expanding the partial drop distribution. The macroscopic shaping of the lattice mask allows all partial drops separated from the originally incident drop to receive a different twist. For multiple (e.g., 100) partial drops, an impulse change which is specific to the partial drops occurs simultaneously.

The mobility of the masking device is illustrated in FIG. 7. Besides the variation of the distance d from the target (see FIG. 3) to change the partial drop distribution, the structure element of the masking device may also be displaced laterally in a plane parallel to the plane of the target, in order to divide each incident drop 1, 2, and 3 in a different mask region 1, 2, and 3, for example. For this purpose, the structure element of the masking device has the shape of a strip-shaped lattice which is drawn through the flight path of the drops generated by the drop generator as the drops are supplied.

The movement of the structure element may occur continuously. The partial drops possibly receive an additional impulse in the movement direction of the lattice mask, which may be taken into consideration in the placement on the target, however. The structure element may also be moved in another way, e.g., to provide an additional rotational impulse in relation to the axis formed by the flight path through a rotational movement of the partial drops.

The separation of the masking device from the target thus has an array of advantages which result from the variability of the distance parameter d (variability of the projection of the partial drop distribution), the physical separation of structure element and target (avoidance of contamination), and the lateral mobility of the structure element (additional impulse). According to the present invention, the partial drops may be electrically charged during the generation on the structure element. With the aid of the modulator device 50 shown in FIG. 1a, a further variation of the charged partial drops may occur under the effect of the external electrical field.

According to a further alteration of the present invention, tilting of the structure element of the masking device in relation to the flight path of the originally generated drop and/or in relation to the target may be provided, in order to modify the generation of the partial drop impulse and/or the application of the partial drop distribution on the target.

The features of the present invention disclosed in the preceding description, the claims, and the figures may be of significance both individually and in any arbitrary combination for the implementation of the present invention in its various embodiments.

1. A dosing method, particularly for microdosing fluid media, in which at least one drop (11) is generated using a drop generator (10) and moved on a free flight path (12), which is directed toward a target (30), characterized in that
the drop (11) strikes a masking device (20) having at least one structure element (21-28), which projects into the flight path (12) and on which at least one partial drop (13, 15-18) is detached from the drop (11), and the at least one partial drop is transferred onto the target.

2. The dosing method according to claim 1, wherein the impulse of the at least one partial drop (13, 15-18) is changed in relation to the impulse of the drop (11) using the masking device (20).

3. The dosing method according to claim 1 or 2, wherein, using the masking device (20), the material composition of the at least one partial drop (13, 15-18) is changed in relation to the composition of the drop by absorbing an additional substance (60) on the structure element (24) of the masking device (20).

4. The dosing method according to one of the preceding claims, wherein a perforated or lattice mask is used as the structure element (24, 26-28) and a division of the drop (11) into multiple partial drops (15-18) occurs.

5. The dosing method according to one of the preceding claims, wherein multiple structure elements (26-28) of at least one masking device (20) are positioned in the movement direction of the drop.

6. The dosing method according to one of the preceding claims, wherein the at least one structure element (21, 24, 26-28) is moved in relation to the flight path (12) of the drop (11) and/or in relation to the target (30) for modification of the partial drop distribution and/or the partial drop paths (12).

7. The dosing method according to one of the preceding claims, wherein the partial drops are electrically charged on at least one structure element (21, 24, 26-28).

8. The dosing method according to one of the preceding claims, wherein the drops (11) include a solution or suspension which contains biological materials, such as cells, cell components, or macromolecules, and/or chemical reactants, such as dissolved polymers or salts.

9. The dosing method according to one of the preceding claims, wherein the target (30) includes a microscope slide, a cultivation plate, a substrate for cell assays, or a fluidic microsystem.

10. A dosing device (100), particularly for microdosing fluid media, having a drop generator (10), which is set up to generate drops (11) which move on a predetermined free flight path (12), characterized by
a masking device (20) having at least one structure element (21, 24, 26-28), at least one edge (22) of which projects into the flight path (12) of the drop (11).

11. The dosing device according to claim 10, wherein the structure element is formed by a perforated or lattice mask (24-28).

12. The dosing device according to claim 10, wherein the structure element is implemented as flat or curved.

13. The dosing device according to one of claims 10 through 12, wherein multiple structure elements (26-28) are provided in sequence in the movement direction of the drops.

14. The dosing device according to one of claims 10 through 13, wherein the structure element (24) is at least partially loaded with an additional substance (60).

15. A use of a dosing method or a dosing device for distributing samples in drops onto substrates or in microsystems for application in biomedicine and biotechnology, for modification of substrate surfaces, or for modification of the drop properties of inkjet printers.
